(19) United States
(12) Patent Application Publication
(10) Pub. No.: US 2004/0205815 A1
(43) Pub. Date: Oct. 14, 2004

(54) Method and apparatus for providing history of viewed TV program

(75) Inventor: Hye Sook Hwang, Seoul (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/779,375

(22) Filed: Feb. 13, 2004

(30) Foreign Application Priority Data
Feb. 13, 2003 (KR) 9065/2003

(51) Int. Cl. H04N 5/445; G06F 3/00; H04H 9/00; H04N 7/16; G06F 13/00

(52) U.S. Cl. 725/46; 725/45; 725/9; 725/14

(57) ABSTRACT

Disclosed is a method and apparatus for providing a history of viewed broadcasting programs. The inventive method provides a history on the respective broadcasting programs viewed for a set time, thereby enabling to perform a true teaching about television viewing and to perform a precise viewing rate search using the viewing times of a specific broadcasting program.

### BACKGROUND OF THE INVENTION

1. Field of the Invention

The present invention relates to a broadcasting receiver, and more particularly, to a method and apparatus in which a history of viewed TV programs can be provided.

2. Description of the Related Art

Generally, an Electronic Program Guide (Hereinafter, referred to as “EPG”) function for guiding broadcasting program information on various programs provided from a plurality of broadcasting stations is used in a broadcasting receiving unit (for example, a set-top box or a television set).

In other words, if program information of each broadcasting station is transmitted over an a special channel for EPG broadcasting, the broadcast receiver decodes the EPG broadcasting channel to convert the decoded broadcasting channel into a display format such that corresponding program information is displayed on a screen.

In South of Korea, a technique is provided in which the program information is provided identically with the EPG function, but its transmission way is different. That is, if each broadcasting station transmits its own broadcasting program information over a 16^{th} odd field of a Virtual Blanking Interval (VBI) of an image signal, the broadcast receiver extracts a KBPS (Korean Broadcasting Program Service) signal during a predetermined time from an image signal of a designated channel to analyze and store the program information. Additionally, the stored program information is displayed on the screen in response to a user's request. At this time, the program information analyzed from the KBPS signal can include a date, a time (that is, a start time and an end time of a corresponding broadcasting program), a title of a broadcasting program, a synopsis, a cast and the like.

The technique for guiding the program using the KBPS signal has been proposed using a KBPS standard. That is, the KBPS standard is a broadcasting signal standard that is regulated to provide various services such as a reserve record mode of the broadcasting program by transmitting digital data of a horizontal scanning line of the VBI among television broadcasting signals to decode the television broadcasting signal in the broadcast receiver such as TV, VCR and TVCR having a tuner embedded.

FIG. 1 is a block diagram illustrating an apparatus for providing a program guide using the KBPS signal in a general broadcast receiver.

Referring to FIG. 1, the general program guiding apparatus includes an antenna 1, a tuner 2, a decoder 3, an A/D converter (Analog/Digital converter) 4, a synchronous signal separating part 5, a KBPS signal extracting part 6, a microprocessor 7, a signal processing part 8, a program ROM 9, a program RAM 10, a PLL (Phase locked loop) 11, an on-screen display (OSD) processing part 12, a font ROM 13, a video RAM 14 and a display part 15.

The antenna 1 receives the broadcasting signal provided from each broadcasting station. At this time, a broadcasting signal corresponding to a channel selected by a user is selected by the tuner 2. That is, if the broadcasting channel wanted by a user is selected, the image signal corresponding to a corresponding broadcasting channel is selected under control of the microprocessor 7 detecting the selected channel. Herein, the image signal includes a video signal, an audio signal and the KBPS signal.

The selected image signal is decoded by the decoder 3, and then is digital-converted by the A/D converter 4. At the same time with this, the synchronous signal separating part 5 separates a complex synchronous signal, a vertical synchronous signal and a horizontal synchronous signal from the image signal. The digital-converted image signal is not illustrated, but is separated into the video signal and the audio signal to be respectively outputted through the screen, a speaker and the like.

Meanwhile, the KBPS signal extracting part 6 refers to the separated synchronous signals to extract the KBPS signal from the digital-converted image signal.

The microprocessor 7 generates a predetermined control signal in response to the user's request to control the tuner 2 and the signal processing part 8.

The signal processing part 8 receives the KBPS signal to control to embody an EPG screen depending on the predetermined control signal of the microprocessor 7.

At this time, program for operating an EPG system is stored in the program ROM 9, and data required at the time of performing the corresponding program of the program ROM is temporarily stored in the program RAM 10.

The PLL 11 refers to the vertical synchronous signal and the horizontal synchronous signal extracted from the image signal to generate a dot clock signal for using to display the EPG screen.

The OSD processing part 12 converts the EPG screen into an OSD format such that the EPG screen can be displayed under control of the signal processing part 8.

For this, font information for a character and the like of the EPG is stored in the font ROM 13, and graphic data for OSD graphic processing is stored in the video RAM 14.

The display part 15 displays the EGP screen generated from the OSD processing part 12.

At this time, the display part 15 is in progress of displaying the video signal previously selected by the user's request.

According to this, a user cannot only more easily understand the corresponding broadcasting program, but also can be served for a guide for a next operation by using the program information on the broadcasting program being currently broadcasted, that is, the date, the time, the title of the broadcasting program, the synopsis, the cast and the like.

However, the conventional program guiding apparatus using the KBPS signal has a disadvantage in that since only information on the currently broadcasted program can be obtained as described above, the program information on other broadcasting programs previously viewed cannot be recognized. That is, the conventional program guiding apparatus cannot recognize information on whether any broadcasting programs are selected and viewed for a predetermined past time.

As a television broadcasting channel is recently diversified, contents of various fields (for example, news, drama, sports, game and adult movie) are provided. These various contents include contents that are impermissible for a people having less than a predetermined age.

However, parents at each home cannot always watch on the television together with children for viewing guide of the children.

Accordingly, the conventional program guiding apparatus using the KBPS signal has a disadvantage in that in absence of parents, since they cannot check the broadcasting programs viewed by the children due to unrecognizability of information on the past viewed program, a right viewing guide cannot be performed for the children.

### SUMMARY OF THE INVENTION

Accordingly, the present invention is directed to a method and apparatus for providing histories of viewed TV programs that substantially obviates one or more problems due to limitations and disadvantages of the related art.

An object of the present invention is to provide a method and apparatus in which histories of viewed TV programs can be provided.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for providing a history of viewed broadcasting programs, the method comprising the steps of: (a) extracting program data from a viewing broadcasting signal; (b) creating an EPG picture using the extracted program data and storing the created EPG picture as the history of the viewed broadcasting programs; and (c) repeatedly performing the steps (a) and (b) for a set time.

Preferably, titles and viewing times of the respective broadcasting programs viewed for a set time are stored in the history.

The aforementioned method may further include the step of setting a storing time of the history in response to the user's set request.

In another aspect of the present invention, there is provided an apparatus for providing a history of viewed broadcasting programs, the apparatus comprises: a tuner for selecting a viewing image signal; means for extracting a program data from the viewing image signal; means for creating an EPG picture using the extracted program data; means for storing the created EPG picture as the history of the viewed broadcasting programs; and means for displaying the viewing image signal, wherein titles and viewing times of the respective broadcasting programs viewed for a set time are stored in the history.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating an apparatus for providing program guidance using a KBPS signal in a general broadcast receiver;

FIG. 2 is a block diagram illustrating an apparatus for providing a history of viewed broadcasting programs in a broadcast receiver according to a preferred embodiment of the present invention;

FIG. 3 is an exemplary diagram illustrating a history displayed on a screen in an apparatus for providing a history of viewed broadcasting programs according to a preferred embodiment of the present invention; and

FIG. 4 is a flowchart illustrating a method for setting and searching a history in an apparatus for providing history of viewed broadcasting program according to a preferred embodiment of the present invention.

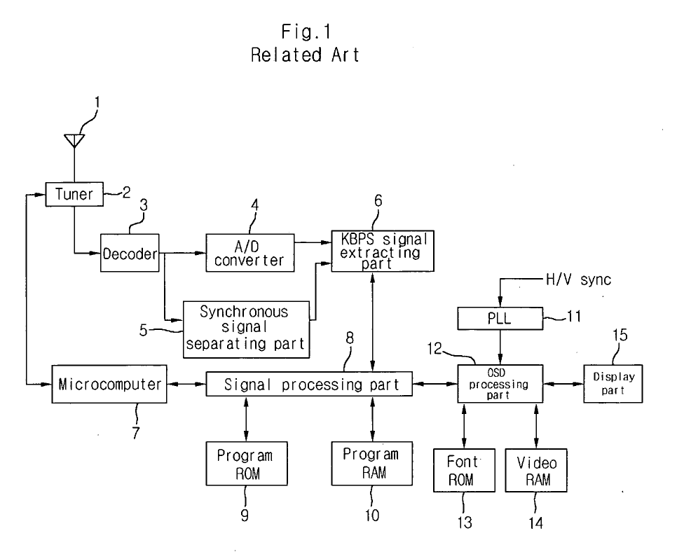

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

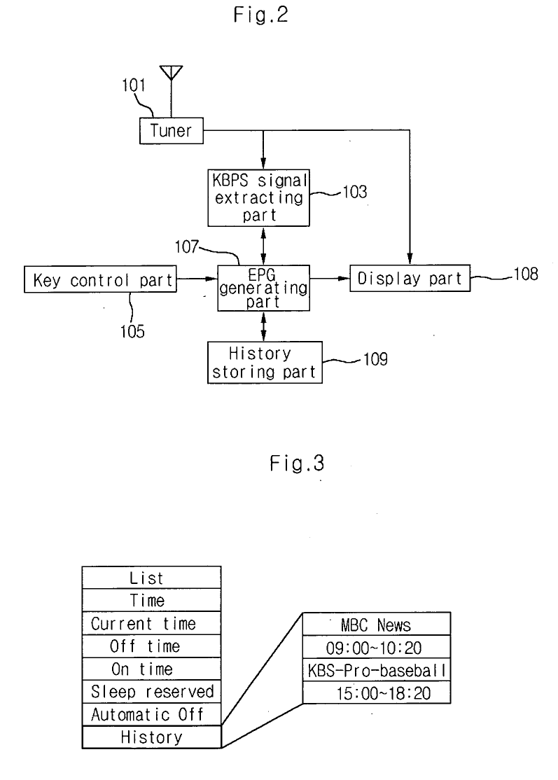

FIG. 2 is a block diagram illustrating an apparatus for providing a history of viewed broadcasting programs in a broadcasting receiver according to a preferred embodiment of the present invention.

Referring to FIG. 2, the apparatus of the present invention includes: a tuner 101 for selecting a viewing image signal; a KBPS signal extracting part 103 for extracting a KBPS signal (i.e., program data) from the viewing image signal selected by the turner 101; an EPG generating part 107 for matching the extracted KBPS signal with a font and processing the matched signal into an OSD signal to thereby generate an EPG screen; a history storing part 109 for storing the EPG screen as a history of the viewed broadcasting programs; and a display part 108 for displaying the viewing image signal. In addition, the apparatus of the present invention can further include a key control part 105 for inputting a user's history searching request and history setting request. At this time, the key control part 105 may be provided with a remote controller, a keyboard, a keypad, and the like.

A user can request the history searching or the history setting to the apparatus through the key control part 105.

At this time, it is preferable to perform an authentication process such that only some specific users are permitted to carry out the history searching request or the history setting request. In other words, the history stores program information of broadcasting programs viewed for a predetermined time (for example, titles and viewing times of the respective broadcasting programs). Some specific users can use it for the viewing guide to children by checking the broadcasting programs viewed for a predetermined time through the searching of the program information.

Accordingly, it is preferable to perform an authentication process to permit parents, not children, to carry out the history searching request or the history setting request.

Hereinafter, the “user” indicates some adults including the parents.

In addition, the user can select desired image signals through the key control part 105. In other words, if a predetermined image signal is selected by the user, a microprocessor (not shown) controls the tuner 101 to select the image signal among various image signals received through the tuner 101.

At this time, in case it is set to store EPG screens as the history, in which the EPG screens are generated by KBPS signals extracted from the image signals that the user views for a predetermined time, the KBPS signal extracting part 103 extracts the KBPS signal from the viewing image signal selected by the tuner 101.

At the same time, the viewing image signal is displayed through the display part 108.

The EPG generating part 107 matches the extracted KBPS signal with a font and processes the matched signal into an OSD signal to thereby generate an EPG screen.

The EPG screen includes a variety of program information (for example, date, time, title of the broadcasting program, synopsis, cast, etc.).

At this time, among the variety of program information, the title or time of the broadcasting program is stored in the history storing part 109 as the history of the viewed broadcasting programs. Here, the “time” means a viewing time determined by a start time and end time of the corresponding broadcasting program.

If another viewing image signal is selected through the tuner 101, a KBPS signal is extracted from the image signal in the above manner and an EPG screen is then generated using the KBPS signal. A title and viewing time of a broadcasting program corresponding to the viewing image signal are stored in the history storing part 109.

The above-described processes are performed repeatedly for a predetermined time set by the user.

Accordingly, titles and viewing times of the respective broadcasting programs that are variously viewed for the set time are sequentially stored in the history. Here, the set time indicates a storage time of the history set by the user.

At this time, in case the user inputs the history searching request through the key control part 105, the history stored in the history storing part 109 is displayed through the display part 108 under a control of the EPG generating part 107.

FIG. 3 is an exemplary diagram illustrating the history displayed on a screen in an apparatus for providing the history of the viewed broadcasting programs according to a preferred embodiment of the present invention.

As shown in FIG. 3, the history can be displayed in a menu form together with menus of other information (for example, time, current time, off time, on time, sleep reserved, automatic off, etc.)

At this time, if the user selects the history menu, the titles and viewing times of the respective broadcasting programs stored for a set time are displayed in a list form.

For example, if the user requests the history searching of the broadcasting programs viewed from 8:00 a.m. to 9:00 p.m. through the key control part 105, the history menu is selected in response to the request such that the titles and viewing times of the corresponding broadcasting programs can be displayed in a list form. Accordingly, the user can know from the list that she or he viewed MBC news from 9:00 a.m. to 10:20 a.m. and KBS pro baseball from 15:00 p.m. to 18:20 p.m. In addition, the user can refer to the viewing guide by checking the broadcasting programs, which children viewed for a predetermined time, through the searching of the program information.

Meanwhile, in case the user does not set the history, the processes are performed in the same manner. However, the titles and viewing times of the corresponding broadcasting programs are not stored in the history storing part 109 as the history. Therefore, any history is not established, so that the history is not displayed on the screen.

However, information related to the broadcasting programs corresponding to the current-viewing image signals may be merely displayed on the screen.

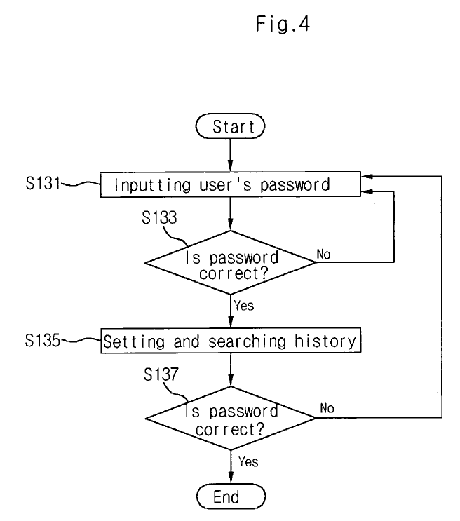

FIG. 4 is a flowchart illustrating a method for setting and searching the history in the apparatus for providing the history of the viewed broadcasting program according to a preferred embodiment of the present invention.

As described above, in order to use the apparatus for providing the history of the viewed broadcasting programs, the history setting and searching processes must be carried out.

At this time, the user must be certified through a predetermined authentication process. This process is performed for strictly limiting the history setting and searching to thereby prevent children from an arbitrary manipulation.

If the user inputs a predetermined password (S131), a user authentication is performed by confirming whether the inputted password and a previously registered password are identical to each other (S133).

If the authentication process is completed, the history setting process or the history searching process is performed (S135). In other words, if the user requests the history setting for a predetermined time, the history is set to be stored in the history storing part 109 for the requested time in response to the request.

In addition, if the user requests the history searching, the apparatus displays the history stored in the history storing part 109 on the screen.

If the history setting or the history searching function is performed as above, the user authentication is performed once again (S137). In other words, the user inputs the passwords again, and then, the user authentication is performed by confirming whether the inputted password is identical to the previously registered password. However, the step S137 is not always necessary and may be selectively performed for its security.

Thus, according to the present invention, particulars of the programs that the user viewed for a specific time can be checked by using the stored history of the respective viewed broadcasting programs, so that it is possible to guide children to a correct TV viewing at home.

In addition, since each history of the broadcasting programs viewed through respective TVs is stored, it is possible to grasp a certain group or individual's TV program inclination and use it as a public information.

For example, in case it is judged through the history function for the viewed programs that a certain group likes a cartoon, the cartoon may be used for a public information of a corresponding product. For a group that likes sports, a sportsman may be cast as a model of a corresponding product.

Further, even when the respective broadcasting companies checks a TV viewing rate of specific programs, the broadcasting companies can calculate an accurate viewing rate by using the number of specific program viewing, which is received through a general transmission method (i.e., a network) from the respective TVs that the history function of the present invention is performed therein.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for providing a history of viewed broadcasting programs, the method comprising the steps of:
(a) extracting program data from a viewing broadcasting signal;
(b) creating an EPG picture using the extracted program data and storing the created EPG picture as the history of the viewed broadcasting programs; and
(c) repeatedly performing the steps (a) and (b) for a set time.

2. The Method of claim 1, further comprising the step of displaying the stored history in response to the user's history search request.

3. The method of claim 1, wherein titles and viewing times of the respective broadcasting programs viewed for a set time are stored in the history.

4. The method of claim 1, further comprising the step of setting a storing time of the history in response to the user's set request.

5. An apparatus for providing a history of viewed broadcasting programs, the apparatus comprises:
a tuner for selecting a viewing image signal;
means for extracting a program data from the viewing image signal;
means for creating an EPG picture using the extracted program data;
means for storing the created EPG picture as the history of the viewed broadcasting programs; and
means for displaying the viewing image signal,
wherein titles and viewing times of the respective broadcasting programs viewed for a set time are stored in the history.

6. The apparatus of claim 5, further comprising means for inputting user's history search request and history set request.

7. The apparatus of claim 5, wherein a storing time of the history is set in response to the user's history set request.
